(19) United States
(12) Patent Application Publication
(10) Pub. No.: US 2007/0297624 A1
(43) Pub. Date: Dec. 27, 2007

(54) Digital audio encoding

(75) Inventor: Paul L. Gilman, Palm Springs, CA (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: SurroundPhones Holdings, Inc.

(21) Appl. No.: 11/805,910

(22) Filed: May 25, 2007

Related U.S. Application Data
(60) Provisional application No. 60/808,931, filed on May 26, 2006.

(51) Int. Cl. H04B 1/00

(52) U.S. Cl. 381/119

(57) ABSTRACT

Methods and apparatus, including computer program products, for digital audio encoding. A method of digital encoding includes receiving an audio source having multiple stems, and generating an enhanced audio wave file from the audio source. Generating can include routing each of the multiple stems to an individual channel in a specific format, compressing each individual channel, passing each individual channel through a limiter, passing each individual channel through an equalizer, and passing each individual channel through a phase shifter. Generating can include time aligning each individual channel, sound modeling each individual channel, and modifying an amplitude of each individual channel, processing each individual channel for sound design, movement and automation, and digitally mixing the multiple channels. Generating can include normalizing and compressing the digitally mixed multi-channel sound recording.

### CROSS REFERENCE TO RELATED APPLICATIONS

This application claims priority to U.S. Provisional Patent Application entitled “METHOD AND APPARATUS FOR PRODUCING SURROUND SOUND THROUGH STEREO HEADPHONES,” filed on May 26, 2006, Ser. No. 60/808,931, the entire contents of which are incorporated herein.

### BACKGROUND

The present invention relates to data processing by digital computer, and more particularly to digital audio encoding.

Multi-channel audio typically refers to a variety of techniques used to expand and enrich the sound of audio playback by recording additional sound channels that can be reproduced on additional speakers. “Surround sound” generally refers to the application of multi-channel audio to channels “surrounding” an audience, i.e., generally some combination of left surround, right surround and back surround. Surround sound systems are typically used in cinema sound systems, home entertainment systems such as “home theater,” video arcade games, computer games, and so forth.

Surround sound specifications include, for example, 3.0 channel surround, 4.0 channel surround, 4.1 channel surround, 5.1 channel surround, 6.1 channel surround, 7.1 channel surround and 10.2 channel surround. These surround sound specifications usually distinguish between the number of discrete channels encoded in an original signal and the number of channels reproduced for playback. The number of channels reproduced for playback can be changed by using matrix encoding, for example. A distinction is also made between the number of channels reproduced for playback and the number of speakers used to reproduce the sound.

### SUMMARY

The present invention provides methods and apparatus, including computer program products, for digital audio encoding.

In general, in one aspect, the invention features a method of digital audio encoding including receiving an audio source having multiple stems, and generating an enhanced audio wave file from the audio source.

In embodiments, the audio source is selected from the group consisting of six-channel audio stems, multi-track audio and stereo-mixed masters.

Generating the enhanced audio wave file can include generating a digital audio source from the audio source if the audio source is analog.

Generating the enhanced audio wave file further can include routing each of the multiple stems to an individual channel in a specific format, and the specific format can be pro tools.

Generating the enhanced audio wave file can further include compressing each individual channel, passing each individual channel through a limiter, passing each individual channel through an equalizer, and passing each individual channel through a phase shifter.

Generating the enhanced audio wave file can further include time aligning each individual channel, sound modeling each individual channel, and modifying an amplitude of each individual channel.

Generating the enhanced audio wave file can further include processing each individual channel for sound design, movement and automation, and digitally mixing the multiple channels.

Generating the enhanced audio wave file further can include normalizing and compressing the digitally mixed multi-channel sound recording.

The method can include outputting the enhanced audio wave file.

In another aspect, the invention features a digital audio encoding method including receiving a digital audio source having multiple stems, the audio source selected from the group consisting of six-channel audio stems, multi-track audio and stereo-mixed masters, and generating an enhanced audio wave file from the audio source, the generating including routing each of the multiple stems to an individual channel in a specific format.

In embodiments, the specific format can pro tools.

Generating can further include compressing each individual channel, passing each individual channel through a limiter, passing each individual channel through an equalizer, and passing each individual channel through a phase shifter.

Generating can further include time aligning each individual channel, sound modeling each individual channel, modifying an amplitude of each individual channel, and processing each individual channel for sound design, movement and automation.

Generating can further include digitally mixing the multiple channels, normalizing and compressing the digitally mixed multi-channel sound recording.

The method can include outputting the enhanced audio wave file.

The invention can be implemented to realize one or more of the following advantages.

A digital audio encoding method enables a quality upgrade to the sound otherwise reproduced by MP3 compressed audio files. The method can be applied to audio programs delivered in-the form of a number of sources, including six-channel audio stems, original multi-track source materials, stereo-mixed masters and so forth.

A digital audio encoding method, when applied to audio signals played back through any set of headphones, including so-called “ear buds,” results in an alteration of a listener's perception of the sounds heard to the extent it produces a modification of the spatial relationships the perceived sounds have to one another; a listener perceives such sounds as if they are occurring all around him/her in a 360° sphere.

Once a digital audio encoding method is applied, a resulting product is delivered as a stereo (two-channel) signal, but the headphones listener perceives the delivered product as if it is a 5.1 surround sound mix.

A digital audio encoding method is compatible with and can be decoded and played back through any digital playback device.

When encoded on physical audio or audio-visual devices (such as CDs or DVDs), a digital audio encoding method enhances a listening experience through stereo speakers while at the same time providing an upgrade in sound for users who listen to physical devices while using headphones.

Audio devices and audio-visual devices encoded with the digital audio encoding method playback through conventional stereo speakers with a wider, richer sound and are compatible with any conventional stereo playback system, including those equipped with noise reduction.

Once an audio source is encoded using the digital audio encoding method, the encoding travels with every copy of the recording, requiring no particular software to replicate the encoded application from copy to copy.

No special headphones/hardware are required to experience content encoded by the digital audio encoding method.

A digital audio encoding method mix can be generated from a variety of audio sources including, for example, 5.1 channel mixes, multi-track source material, interim sub-mixes, other groupings generated for audio or audio-visual productions, and so forth.

A digital audio encoding method can be applied to a wide spectrum of entertainment content including, for example, sound recordings, motion pictures, television programs, videogames, ring tones, entertainment content distributed by mobile television (TV) devices and any other products using otherwise conventional stereo sound whether recorded on film, videotape, disc or other matrices capable of carrying stereo sound.

A digital audio encoding method generates encoded content that improves sound in automobiles equipped with multi-speaker systems.

DVD's can have a “button” of choice in their audio menu for files generated by the digital audio encoding method, providing a unique listening option for consumers who do not have “in-home” 5.1 surround sound systems.

Files generated using the digital audio encoding method require no more space/memory on a DVD than a conventional MPEG-1 Audio Layer-3 (MP3) file.

One implementation of the invention can provide all of the above advantages.

Other features and advantages of the invention are apparent from the following description, and from the claims.

### BRIEF DESCRIPTION OF THE DRAWINGS

FIG. 1 is a block diagram of an exemplary data processing system.

FIG. 2 is a flow diagram of a digital audio encoding process.

Like reference numbers and designations in the various drawings indicate like elements.

### DETAILED DESCRIPTION

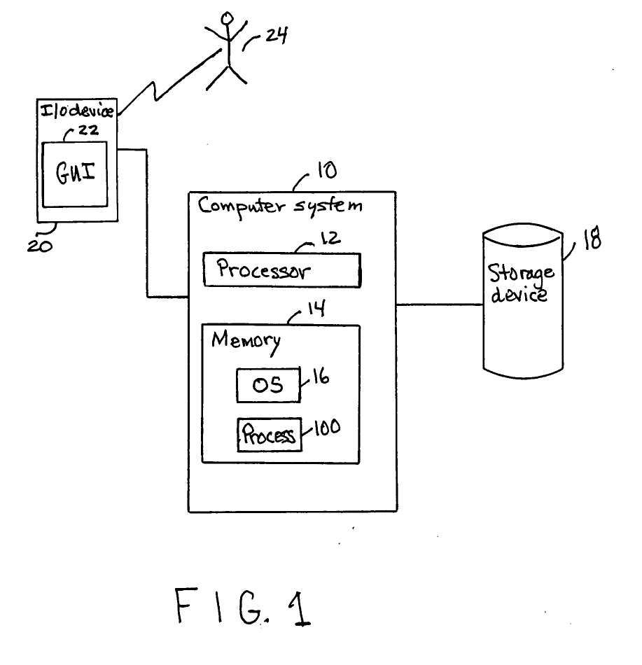

As shown in FIG. 1, an exemplary computer system 10 includes a processor 12 and memory 14. Memory 14 can include an operating system (OS) 16, such as Linux, Windows, or Apple, and a digital audio encoding process 100. The system 10 may include a storage device 18 and input/output (I/O) device 20 for display of a graphical user interface (GUI) 22 to a user 24.

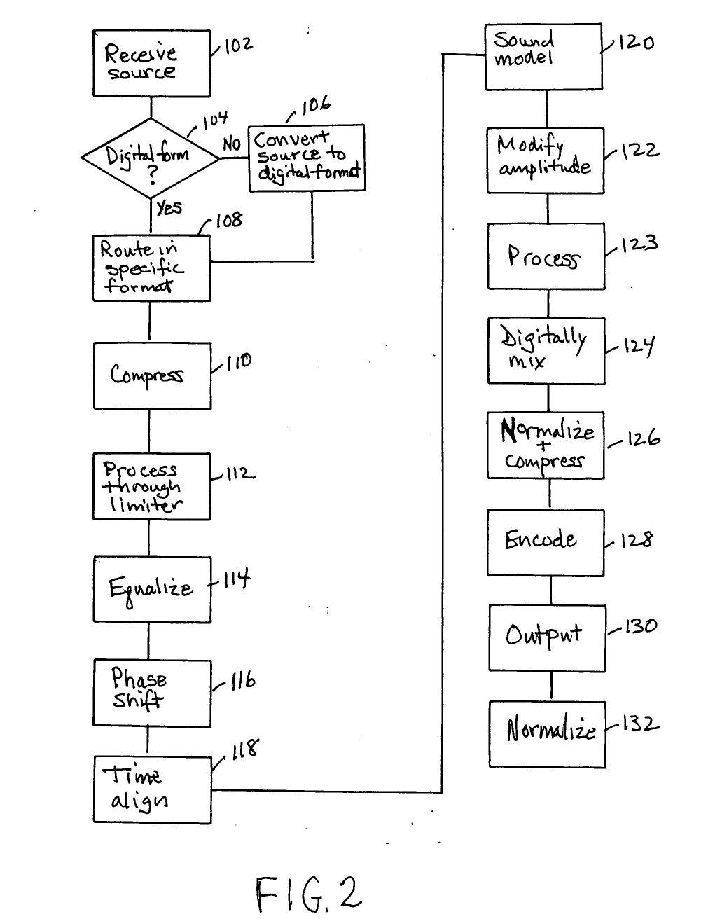

As shown in FIG. 2, the digital audio encoding process 100 includes receiving (102) an original source. The original source is typically a multi-track (also referred to as multi-channel or multiple stem) sound recording. Process 100 determines (104) whether the received original source is in digital form.

One example of an original source is Digital Audio Tape (DAT). DAT is a standard medium and technology for the digital recording of audio on tape at a professional level of quality. A DAT drive is a digital tape recorder with rotating heads similar to those found in a video deck. Most DAT drives can record at sample rates of 44.1 kHz, the CD audio standard, and 48 kHz. DAT has become the standard archiving technology in professional and semi-professional recording environments for master recordings. Digital inputs and outputs on professional DAT decks enable the user to transfer recordings from the DAT tape to an audio workstation for precise editing. The compact size and low cost of the DAT medium makes it an excellent way to compile the recordings that are going to be used to generate a CD master.

If the received original source is in analog form, process 100 converts (106) the analog source to a digital matrix. Analog-to-digital conversion is a process in which a continuously variable, i.e., analog, signal is changed, without altering its essential content, into a multi-level. i.e., digital, signal. The input to an analog-to-digital converter (ADC) includes a voltage that varies among a theoretically infinite number of values. Examples are sine waves, the waveforms representing human speech, and the signals from a conventional television camera. The output of the ADC, in contrast, has defined levels or states. The number of states is almost always a power of two, i.e., 2, 4, 8, 16, and so forth. The simplest digital signals have only two states, and are called binary.

Process 100 routes (108) each channel of the original digital source, or in the event of an analog source, digital source converted from the analog source, in a specific format, such as a Pro Tools® format. Conversion into the Pro Tool® format provides the user with the dynamic range, phasing and spatial flexibility required to generate an enhanced wave file.

Pro Tools® is a computer-based digital music production system. Though usually referred to simply as “Pro Tools,” the Pro Tools® systems are a combination of Pro Tools® software and related hardware which are typically divided into three basic categories, i.e., Pro Tools LE®, Pro Tools® M-Powered, and Pro Tools/HD®.

Pro Tools LE® systems are capable of serving as self-contained 32-track project studios. They enable a user to record, edit, mix, master, and deliver your finished product.

Pro Tools® M-Powered is a version of Pro Tools® software that is compatible with a wide variety of M-Audio® audio interfaces and control surfaces. With Pro Tools® M-Powered and an M-Audio® interface, a user can record, mix, and edit anywhere, anytime with the industry standard in music production software. Sessions generated in Pro Tools® M-Powered can also be transferred to LE and HD systems and back.

Pro Tools/HD® is a high definition, fully integrated professional production system with expandable input/output (I/O), dedicated processing power and a wide array of optional components. HD systems provide the power and flexibility for a user to record, edit, mix, master, and deliver world-class productions. The professional-level Pro Tools/HD® system uses PCI or PCI Express cards to perform audio processing on Digital Signal Processing (DSP) chips to reduce computing burden on the central processing unit (CPU). Similarly, it utilizes TDM (a proprietary interconnect based on time-division multiplexing) to communicate with external I/O devices and other DSP cards to reduce burden on the computer's PCI bus.

Pro Tools H/D® uses three types of PCI-X/PCIe cards. Each Pro Tools® system requires at least one “core” card. All cards contain nine DSP chips. Additional Process and Accel cards can be added to a system to increase capability (it is possible to mix the types), up to a total of seven cards.

Process 100 compresses (110) each individual channel. The compressor performs compression on the channel and results in a reduction in size of data in order to save space or transmission time. Audio compression algorithms are typically implemented in computer software as audio codecs. Specific audio “lossless” and “lossy” algorithms are generated. Lossy algorithms provide far greater compression ratios and are used in mainstream consumer audio devices. Lossy audio compression is used in an extremely wide range of applications. In addition to the direct applications (e.g., MP3 players or computers), digitally compressed audio streams are used in most video DVDs, digital television, streaming media on the Internet, satellite and cable radio, and increasingly in terrestrial radio broadcasts. Lossy compression typically achieves far greater compression than lossless compression (data of 5 percent to 20 percent of the original stream, rather than 50 percent to 60 percent), by discarding less-critical data.

Lossy audio compression uses so-called “psychoacoustics” to recognize data in an audio stream that can be perceived by the human auditory system. Most lossy compression reduces perceptual redundancy by first identifying sounds, which are considered perceptually irrelevant, that is, sounds that are very hard to hear. Typical examples include high frequencies, or sounds that occur at the same time as other louder sounds. Those sounds are coded with decreased accuracy or not coded at all.

Process 100 processes (112) each individual channel through a limiter. In general, a limiter is a circuit that enables signals below a set value to pass unaffected clips off the peaks of stronger signals that exceed this set value. A limiter is a compressor with a higher ratio, and generally a faster attack time. While there is no absolute consensus on what ratio constitutes limiting as compared with compression, most recording engineers would consider anything with a ratio greater than 10:1 as limiting. Compression and limiting are no different in process, just in degree and in the perceived effect. Engineers sometimes refer to soft and hard limiting which are differences of degree. The “harder” a limiter, the lower its threshold and the higher its ratio.

“Brick wall limiting” effectively ensures that an audio signal never exceeds the amplitude threshold that is set. In practice, this is a ratio of 50:1 or greater. Sometimes it is labeled as ∞:1 The sonic results of more than momentary and infrequent hard limiting are usually characterized as harsh and unpleasant; thus it is more appropriate as a safety device in live and broadcast applications than as a sound-sculpting tool.

Process 100 equalizes (114) each individual channel. When listening to music, a listener might desire to hear the vocals which are getting “drowned-out” by a strong bass section. This can be accomplished by respectively attenuating the low-frequency bass section while amplifying the higher-frequency vocal section. This process is known as audio equalizing. Dynamic equalization can be a useful technique for representing auditory occlusion. It is often not sufficient for a user to hear an auditory icon; the user needs to be able to determine the location of the associated visual interface object in order to manipulate it accordingly. Stereo panning is thus employed in the process in displaying information along the horizontal azimuth, and equalization, or filtering can be useful in presenting information about the “z” axis.

Process 100 phase shifts (116) each individual channel. In general, a phase shifter is a device used to adjust transmission phase in a channel. In electronic signaling, phase is a definition of the position of a point in time (instant) on a waveform cycle. A complete cycle is defined as 360 degrees of phase. Phase can also be an expression of relative displacement between or among waves having the same frequency. Equalizers initially were produced to work in an analog sphere are electronic circuits using capacitors and inductors. These components shift the phase of AC signals passing through them. Thus if one combines a signal with a phase shifted version of itself (after passing through the capacitor or inductor), the frequency response is altered. As one cycle of the wave is rising, the shifted version is falling, or perhaps it hasn't yet risen as high. So when the two are combined they partially cancel at some frequencies only thus generating a non-flat frequency response. Analog equalizers were positioned to work by intentionally shifting phase, and then combining the original signal with the shifted version. Their efficacy may be said to be entirely dependent upon the inclusion of phase shift. In our digital context, a surround-sound decoder that supports a central channel picks out the identical signals in the A stream and B stream based on their pattern and amplitude. In a surround setup with no center speaker, the perfectly balanced center signals will generate a so-called “phantom speaker” (the illusion of a speaker) directly in between the left and right speakers. The sound signal for the surround channel is also recorded on stream A and stream B, but the identical signals in each stream are out of phase with each other. Instead of playing in synchrony, they are shifted in time in both audio streams. The result is that the two signals work opposite one another. When the surround signal in stream A tells the left speaker cone to move out, the signal in stream B tells the right speaker cone to move in. Because of this, the surround signal information coming from the front left and front right speakers largely cancels itself out, and you don't hear it. A surround-sound decoder receives both stream A and stream B and shifts them relative to one another so the surround signals are in phase again. With this shift, the right, left and center signals are all out of phase, and so tend to cancel each other out.

Process 100 time aligns (118) each channel. First, time-alignment is important between channels where depth and location information are to be ascertained from recorded material. Time-alignment is important between channels where depth and location information are to be ascertained from recorded material. In order to achieve maximum spatial resolution out of a playback system, time alignment becomes imperative. Time-alignment involves generating incremental delay adjustments calculated at the rate of milliseconds. Some DVD Audio and SACD configurations have provisions for time-alignment, including Dolby-Digital® and DTS playback systems. In order to operate effectively, output levels are carefully adjusted in order to display ambient, environmental information. Within a pair of headphones, sound is displayed in a manner to generate what is perceived as a multi-speaker array approximating the effect of dipolar surround speakers, which inherently force a diffuse sound field, in which case the arrivals and direction are so spread across and spectrum perceived as in excess of 180°.

The assumption is that in achieving time-alignment, the listener perceives a center channel stabilized in the form of a the front sonic soundstage, which in a two-channel playback environment, exists in a space equidistant from what would be left and right speakers that still satisfies the 40-60 degree spread that two-channel reproduction requires. Thus, we maintain within the headphones the perception of depth captured or generated in the recording. Balance control may be accessed in order to compensate for amplitude variations, not time differences, and accordingly may be useful is dealing with linear delay.

Pan pots on the mixing console may be employed in the context of most studio recordings which try to capture sounds in a single channel with as close to no acoustical environment as possible (i.e. a sound-proof booth) and then mix the sounds with pans amidst a variety of processing, and then filled out with artificial reverberation (usually) to compensate for the lack of ambient information.

Process 100 sound models (120) each channel.

Process 100 modifies (122) an amplitude of each channel. Amplitude may be defined generally as the strength of a vibrating wave; in sound, the loudness of the sound. In its simplest form, process 100 uses the same two recording or transmission channels as conventional stereo, utilizing both amplitude and phase to convey a full 360-degree, horizontal sound stage. Further enhancement of the quality of sound images around the listener is achieved by adding additional transmission channels to the basic two-channel encoding. The effect of full-sphere portrayal of directionality, including sounds above and below the horizontal sound field, can be conveyed by the addition of another supplementary channel for height information. Files generated by process 100 and conventional 5.1 surround sound are very different. 5.1 is generated vis a vis an array of set speaker feeds, the signal only being fully defined for sounds coming from a particular speaker.

Conventional pair-wise mixing is also called “pan-potting”, “amplitude mixing” and “intensity stereophony”. The technique mixes signals into the feeds for a pair of speakers to generate the illusion that a sound is coming from a point somewhere between the speakers. During mixing, the apparent location of each sound is determined only by the relative amplitude of that sound in the two speakers. Thus, in the context of a headphone mix, the desired result is sought to be achieved in much the same manner but perceived by the listener as up to and including a 360° degree point of reference. Process 100 generated files is thus fundamentally different from 5.1. oriented for distribution through speakers. What is encoded in process 100 is not speaker feeds, but direction. When mixing in process 100, the positions of the speakers are unknown and are of no interest. When a process 100 file is decoded and played back on a digital device utilizing stereo headphones, the resulting two channels of sound, emulating the 5.1 mix cooperate to localize each sound in its correct position vis a vis the mix. Thus the perception of a 5.1 mix contained within the two-channel stereo context combine contributing to the generation of a single coherent sound field.

Process 100 processes (123) each channel for sound design, movement and automation. Level and stereo pan changes occur in process 100 during the mix-down process. Smooth fades in and out, instantaneous pan changes that are modulated to a specific rhythm, usually require quite a bit of physical coordination and they are difficult to repeat. Effected in an automated environment, process 100 incorporates a fully automated mix-down process. The mix-down is automated by means of the creation of a visual edit volume and pan envelopes in Pro Tools®. This may take the form of traditional real-time mixer automation that is based on the idea of performing a mix and recording the motion of the faders into Pro Tools® memory. This mixer-based automation also generates automation envelopes that can be edited visually with on-screen display windows. To accomplish mixer-based automation, Pro Tools® and the associated plug-ins employed utilize the concepts of real-time fader motion recording, mixer states, and transition time. Real-time fader motion recording records the actual movement of what would otherwise be mixer faders, thus intuitively generating an automated mix. Mixer state automation takes the form of a picture of the current position of every fader on the mixer. Each state is stored in memory, and each can be recalled at any time. A fixed transition time can be set, and that time is always used to fade smoothly between each mixer state.

Process 100 digitally mixes (124) all channels. A mixer is a device that enables a user to balance, position, effect and equalize its different audio channels into a good sounding sonic image called a mix. Effects can be added to some channels but not others, instruments positioned to a location in the stereo field, channels routed to outboard gear that produces an interesting effect and “sculpt” the sound of each channel with a dedicated equalizer where the user can vary the bass, treble and mid range. Process 100 undertakes sound sculpting, an environment in which the mixer can generate, edit or perform sounds by changing parameters, like position, orientation and shape of a virtual object as input device, that can only be perceived through its visual and acoustic representations.

Process 100 normalizes and compresses (126) the multi-channel sound recording.

Process 100 encodes (128) the multi-channel sound recording. In a preferred example, a Dolby® encoder is utilized.

Advanced Audio Coding (AAC) is a standardized, lossy compression and encoding scheme for digital audio. AAC usually achieves better sound quality than the more popular MP3 format when compared at the same bit rate, especially for bit rates below about 100 kilobytes per second.

It is the default, and most commonly used format for compressing audio CDs for Apple's iPod® and iTunes® (Extension .m4a). Apple uses the AAC format for all audio for sale on the iTunes Store and a special proprietary .m4p container for DRM restricted files.

AAC is also used as the standard audio file for Sony's Playstation 3 and as the default audio codec for the .m4v format that Apple employs in its iTunes Store video files.

AAC was developed with the cooperation and contributions of companies including Dolby, Fraunhofer (FhG), AT&T, Sony and Nokia, and was officially declared an international standard by the Moving Pictures Experts Group in April 1997.

It is specified both as Part 7 of the MPEG-2 standard, and Part 3 of the MPEG-4 standard. As such, it can be referred to as MPEG-2 Part 7 and MPEG-4 Part 3 depending on its implementation, however it is most often referred to as MPEG-4 AAC, or AAC for short.

AAC was first specified in the standard MPEG-2 Part 7 (known formally as ISO/IEC 13818-7:1997) in 1997 as a new “part” (distinct from ISO/IEC 13818-3) in the MPEG-2 family of international standards.

It was updated in MPEG-4 Part 3 (known formally as ISO/IEC 14496-3:1999) in 1999. The reference software specified in MPEG-4 Part 4 and the conformance bit streams are specified in MPEG-4 Part 5. A notable addition in this version of the standard is Perceptual Noise Substitution (PNS).

HE-AAC (AAC with SBR) was first standardized in ISO/IEC 14496-3:2001/Amd.1. HE-AAC v2 (AAC with Parametric Stereo) was first specified in ISO/IEC 14496-3:2001/Amd.4. [1]

The current version of the AAC standard is ISO/IEC 14496-3:2005 (with 14496-3:2005/Amd.2. for HE-AAC v2[2])

AAC Plus v2 is also standardized by ETSI (European Telecommunications Standards Institute) as TS 102005.

The MPEG4 standard also contains other ways of compressing sound. These are low bit rate and generally used for speech.

AAC was designed to have better performance than MP3 (which was specified in MPEG-1 and MPEG-2) by the ISO/IEC in 11172-3 and 13818-3.

Improvements include, for example, more sample frequencies (from 8 kHz to 96 kHz) than MP3 (16 kHz to 48 kHz), ip to 48 channels (MP3 supports up to two channels in MPEG-1 mode and up to 5.1 channels in MPEG-2 mode), arbitrary bit rates and variable frame length. Standardized constant bit rate with bit reservoir, Higher efficiency and simpler filter bank (hybrid→pure MDCT), and higher coding efficiency for stationary signals (block size: 576→1024 samples). Improvements also include higher coding efficiency for transient signals (block size: 192→128 samples), can use Kaiser-Bessel derived window function to eliminate spectral leakage at the expense of widening the main lobe, much better handling of audio frequencies above 16 kHz, more flexible joint stereo (separate for every scale band), adds additional modules (tools) to increase compression efficiency (TNS, Backwards Prediction, PNS, and so forth). These modules can be combined to constitute different encoding profiles.

Overall, the AAC format allows developers more flexibility to design codecs than MP3 does. This increased flexibility often leads to more concurrent encoding strategies and, as a result, to more efficient compression. However in terms of whether AAC is better than MP3, the advantages of AAC are not entirely conclusive, and the MP3 specification, while outdated, has proven surprisingly robust. AAC and HE-AAC are better than MP3 at low bit rates (typically less than 128 kilobytes per second). At medium to higher bit rates (typically in excess of 128 kilobytes per second stereo), the two formats are more comparable in most respects.

AAC is a wideband audio coding algorithm that exploits two primary coding strategies to dramatically reduce the amount of data needed to represent high-quality digital audio. Signal components that are perceptually irrelevant are discarded. Redundancies in the coded audio signal are eliminated. Furthermore, the signal is processed by a modified discrete cosine transform (MDCT) according to its complexity, internal error correction codes are added, the signal is stored or transmitted and in order to prevent corrupt samples, a modern implementation of the Luhn mod N algorithm is applied to each frame.

The MPEG-4 audio standard does not define a single or small set of highly efficient compression schemes but rather a complex toolbox to perform a wide range of operations from low bit rate speech coding to high-quality audio coding and music synthesis. The MPEG-4 audio coding algorithm family spans the range from low bit rate speech encoding (down to 2 kilobytes per second) to high-quality audio coding (at 64 kilobytes per second per channel and higher). AAC offers sampling frequencies between 8 kHz and 96 kHz and any number of channels between 1 and 48. In contrast to MP3's hybrid filter bank, AAC uses the modified discrete cosine transform (MDCT) together with the increased window lengths of 1024 points. AAC is much more capable of encoding audio with streams of complex pulses and square waves than MP3 or MP2.

AAC encoders can switch dynamically between a single MDCT block of length 1024 points or 8 blocks of 128 points. If a signal change or a transient occurs, 8 shorter windows of 128 points each are chosen for their better temporal resolution. By default, the longer 1024-point window is otherwise used because the increased frequency resolution allows for a more sophisticated psychoacoustic model, resulting in improved coding efficiency.

AAC takes a modular approach to encoding. Depending on the complexity of the bit stream to be encoded, the desired performance and the acceptable output, implementers may generate profiles to define which of a specific set of tools they want use for a particular application. The standard offers four default profiles, i.e., Low Complexity (LC)—the simplest and most widely used and supported, Main Profile (MAIN)—like the LC profile, with the addition of backwards prediction, Sample-Rate Scalable (SRS), a.k.a. Scalable Sample Rate (MPEG-4 AAC-SSR), and Long Term Prediction (LTP); added in the MPEG-4 standard—an improvement of the MAIN profile using a forward predictor with lower computational complexity.

Depending on the AAC profile and the MP3 encoder, 96 kilobytes per second AAC can give nearly the same or better perceptional quality as 128 kilobytes per second MP3.[2]

The MPEG-4 Low Delay Audio Coder (AAC-LD) is designed to combine the advantages of perceptual audio coding with the low delay necessary for two-way communication. It is closely derived from the MPEG-2 Advanced Audio Coding (AAC) format.

The most stringent requirements are a maximum algorithmic delay of only 20 ms and a good audio quality for all kind of audio signals including speech and music. The AAC-LD coding scheme bridges the gap between speech coding schemes and high quality audio coding schemes.

Process 100 outputs (130) an enhanced sound wave file. The enhanced six (6) channel sound wave file is normalized (132), taking the form of an enhanced two (2) channel stereo file within which spatial movement is periodically effected on an automated basis. Final output, reducible to an MP-3 format, is achieved while the mixer listens through an accurate monitoring system calibrated in accordance with engineering standards set by the Audio Engineering Society (AES). All specifications are compatible with playback standards for 5.1 systems. The format provides for the serial digital transmission of two channels of periodically sampled and uniformly quantized audio signals on a single shielded twisted wire pair. The transmission rate is such that samples of audio data, one from each channel, are transmitted in time division multiplex in one sample period. Provision is made for the transmission of both user and interface related data as well as of timing related data, which may be used for editing and other purposes. It is expected that the format will be used to convey audio data that have been sampled at any of the sampling frequencies recognized by the AES5, Recommended Practice for Professional Digital Audio Applications Employing Pulse-Code Modulation.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A method of digital encoding comprising:
receiving an audio source having multiple stems; and
generating an enhanced audio wave file from the audio source.

2. The method of claim 1 wherein the audio source is selected from the group consisting of six-channel audio stems, multi-track audio and stereo-mixed masters.

3. The method of claim 1 wherein generating the enhanced audio wave file comprises generating a digital audio source from the audio source if the audio source is analog.

4. The method of claim 3 wherein generating the enhanced audio wave file further comprises routing each of the multiple stems to an individual channel in a specific format.

5. The method of claim 4 wherein the specific format is pro tools.

6. The method of claim 4 wherein generating the enhanced audio wave file further comprises compressing each individual channel.

7. The method of claim 6 wherein generating the enhanced audio wave file further comprises:
passing each individual channel through a limiter;
passing each individual channel through an equalizer; and
passing each individual channel through a phase shifter.

8. The method of claim 7 wherein generating the enhanced audio wave file further comprises time aligning each individual channel.

9. The method of claim 8 wherein generating the enhanced audio wave file further comprises sound modeling each individual channel.

10. The method of claim 9 wherein generating the enhanced audio wave file further comprises modifying an amplitude of each individual channel.

11. The method of claim 10 wherein generating the enhanced audio wave file further comprises processing each individual channel for sound design, movement and automation.

12. The method of claim 11 wherein generating the enhanced audio wave file further comprises digitally mixing the multiple channels.

13. The method of claim 12 wherein generating the enhanced audio wave file further comprises normalizing and compressing the digitally mixed multi-channel sound recording.

14. The method of claim 13 further comprising outputting the enhanced audio wave file.

15. A digital audio encoding method comprising:
receiving a digital audio source having multiple stems, the audio source selected from the group consisting of six-channel audio stems, multi-track audio and stereo-mixed masters; and
generating an enhanced audio wave file from the audio source, the generating comprising routing each of the multiple stems to an individual channel in a specific format.

16. The digital audio encoding method of claim 15 wherein the specific format is pro tools.

17. The digital audio encoding method of claim 15 wherein generating further comprises compressing each individual channel.

18. The digital audio encoding method of claim 17 wherein generating further comprises:
passing each individual channel through a limiter;
passing each individual channel through an equalizer; and
passing each individual channel through a phase shifter.

19. The digital audio encoding method of claim 18 wherein generating further comprises time aligning each individual channel.

20. The digital audio encoding method of claim 19 wherein generating further comprises:
sound modeling each individual channel;
modifying an amplitude of each individual channel; and
processing each individual channel for sound design, movement and automation.

21. The digital audio encoding method of claim 20 wherein generating further comprises digitally mixing the multiple channels.

22. The digital audio encoding method of claim 21 wherein generating further comprises normalizing and compressing the digitally mixed multi-channel sound recording.

23. The digital audio encoding method of claim 22 further comprising outputting the enhanced audio wave file.
